(19) United States
(12) Patent Application Publication
(10) Pub. No.: US 2026/0295717 A1
(43) Pub. Date: Oct. 1, 2026

(54) WELDED BODY, METHOD FOR FRICTION STIR SPOT WELDING, AND DEVICE FOR FRICTION STIR SPOT WELDING

(71) Applicants: KAWASAKI JUKOGYO KABUSHIKI KAISHA, Kobe-shi, Hyogo (JP); NISSAN MOTOR CO., LTD., Yokohama-shi, Kanagawa (JP)

(72) Inventors: Masahiro MIYAKE, Kobe-shi (JP); Naoki TAKEOKA, Kobe-shi (JP); Tomonori MIYAZAWA, Kanagawa (JP); Daisuke OIKI, Kanagawa (JP); Li GAO, Kanagawa (JP)

(73) Assignees: KAWASAKI JUKOGYO KABUSHIKI KAISHA, Kobe-shi, Hyogo (JP); NISSAN MOTOR CO., LTD., Yokohama-shi, Kanagawa (JP)

(21) Appl. No.: 19/100,753

(22) PCT Filed: Jul. 31, 2023
(86) PCT No.: PCT/JP2023/027992

§ 371 Date: Feb. 3, 2025

(30) Foreign Application Priority Data
Aug. 4, 2022 (JP) 2022-124889

(51) Int. Cl. B23K 20/12

(52) U.S. Cl. CPC B23K 20/1265; B23K 20/1225; B23K 20/123

(57) ABSTRACT

A welded body includes an upper plate, a lower plate, and a stir-welded portion in which the upper plate and the lower plate are welded together. The upper plate has an upper plate front surface and an upper plate back surface. The lower plate has a lower plate front surface and a lower plate back surface. The stir-welded portion includes a welding bottom surface that is an interface of the upper plate and the lower plate, an anchor and a hooking that are raised parts of the lower plate, and an indent that is a recess in the upper plate front surface of the upper plate.

### TECHNICAL FIELD

The present disclosure relates to a welded body in which a plurality of metal members are welded together, a method for friction stir spot welding for welding a plurality of metal members, and a friction stir spot welding device.

### BACKGROUND ART

A welded body in which a plurality of metal members are welded together may be used as a constituent member of a structure such as an aircraft, a railway vehicle, or an automobile. As one of such welding methods, a method for friction stir spot welding is known.

Patent Literature 1 discloses a welding method for forming a welded body by performing friction stir spot welding on three sheets of metal members by using a double-acting rotary tool including a probe, an inner shoulder member, and an outer shoulder member that are coaxially arranged. The inner shoulder member has a cylindrical shape enclosing the cylindrical probe, and the outer shoulder member has a cylindrical shape enclosing the inner shoulder member. In this technique, the probe and the inner shoulder member are press-fitted in advance to a vicinity of an interface of a first sheet and a second sheet of the three sheets of metal members that are spot-welded in a state where distal end surfaces of the probe and the inner shoulder member are flush with each other to perform friction stirring, and the probe is protruded from the inner shoulder member and further press-fitted to a vicinity of an interface of the second sheet and a third sheet to form a stir-welded portion in which the three sheets of metal members are spot-welded in the overlapping portion.

In the welded body welded by friction stir spot welding, a slight but sudden fracture may occur. The fracture includes an interface fracture in which a fracture progresses along an interface of adjacent metal members inside the welded body, and a plug fracture in which a fracture progresses toward an outer surface of the welded body so as to cross the interface. When such a fracture occurs suddenly in a manufacturing stage, it is necessary to accurately extract the welded body in which the fracture has occurred in a quality confirmation stage after the manufacturing. Therefore, it is desirable that the fracture can be visually recognized from the outside. However, in the conventional welded body as described in Patent Literature 1, there is a problem that it is difficult to control occurrence of a plug fracture and an interface fracture in the welded body.

### CITATION LIST

### Patent Literature

Patent Literature 1: JP 2006-320924 A

### SUMMARY OF INVENTION

An object of the present disclosure is to provide a welded body, a method for friction stir spot welding, and a friction stir spot welding device capable of reducing occurrence of an unstable interface fracture and controlling a plug fracture as a fracture mode.

A welded body according to an aspect of the present disclosure includes a first member including a metal and having a first front surface and a first back surface, a second member that includes a metal, has a second front surface and a second back surface, and is disposed to form an overlapping portion in which at least a part of the second front surface abuts on the first back surface and the first member and the second member overlap each other, and a welded portion in which the first member and the second member are welded by friction stir welding. The welded portion includes a welding bottom surface that is a ring-shaped interface of the first member and the second member and is generated at a position deeper than the second front surface with respect to the first front surface, an inner raised portion in which a part of the second member is raised to a position higher than the second front surface with respect to the welding bottom surface on a radially inner side of the welding bottom surface, an outer raised portion in which a part of the second member is raised to a position higher than the second front surface with respect to the welding bottom surface on a radially outer side of the welding bottom surface, and a recessed portion that is disposed to face the welding bottom surface in an overlapping direction of the first member and the second member and in which a part of the first front surface is recessed.

A method for friction stir spot welding according to another aspect of the present disclosure includes welding a first member that includes a metal and has a first front surface and a first back surface and a second member that includes a metal and has a second front surface and a second back surface by softening the first member and the second member with frictional heat. The method for friction stir spot welding includes preparing a friction stir spot welding device including a pin and a shoulder having a cylindrical shape and a hollow portion into which the pin is inserted, arranging the first member and the second member to form an overlapping portion in which at least a part of the second front surface abuts on the first back surface and the first member and the second member overlap each other, arranging the pin and the shoulder to face the overlapping portion, press-fitting the shoulder to a press-fitting position deeper than the second front surface with respect to the first front surface in the overlapping portion in a state where the pin is retracted from the first front surface, and forming a welding bottom surface that is an interface of the first member and the second member, after forming the welding bottom surface, retracting the shoulder from the press-fitting position and causing the pin to enter the overlapping portion, and forming a recessed portion that is disposed to face the welding bottom surface in an overlapping direction of the first member and the second member and in which a part of the first front surface is recessed by the shoulder and the pin, and along with formation of the welding bottom surface and the recessed portion, forming an inner raised portion in which a part of the second member is raised to a position higher than the second front surface with respect to the welding bottom surface on a radially inner side of the welding bottom surface, and forming an outer raised portion in which a part of the second member is raised to a position higher than the second front surface with respect to the welding bottom surface on a radially outer side of the welding bottom surface.

A friction stir spot welding device according to another aspect of the present disclosure welds a first member that includes a metal and has a first front surface and a first back surface and a second member that includes a metal and has a second front surface and a second back surface by softening the first member and the second member with frictional heat. The friction stir spot welding device includes a welding tool including a pin having a central axis, the welding tool including a shoulder having a cylindrical shape and a hollow portion into which the pin is inserted, a rotation mechanism that allows the welding tool to rotate about the central axis, a movement mechanism that allows each of the pin and the shoulder to move independently in a direction in which the central axis extends, and a control unit that controls each of the rotation mechanism and the movement mechanism. In a state where the first member and the second member are disposed to form an overlapping portion in which at least a part of the second front surface abuts on the first back surface and the first member and the second member overlap each other, and the pin and the shoulder are disposed to face the overlapping portion, the control unit controls each of the rotation mechanism and the movement mechanism to cause the pin to retract from the first front surface, press-fit the shoulder to a press-fitting position deeper than the second front surface with respect to the first front surface in the overlapping portion, and form a welding bottom surface that is an interface of the first member and the second member by the shoulder, after formation of the welding bottom surface, the control unit controls each of the rotation mechanism and the movement mechanism to cause the shoulder to retract from the press-fitting position, cause the pin to enter the overlapping portion, and form, by the shoulder and the pin, a recessed portion that is disposed to face the welding bottom surface in an overlapping direction of the first member and the second member and in which a part of the first front surface is recessed, and along with formation of the welding bottom surface and the recessed portion, the control unit controls each of the rotation mechanism and the movement mechanism to form an inner raised portion in which a part of the second member is raised to a position higher than the second front surface with respect to the welding bottom surface on a radially inner side of the welding bottom surface, and an outer raised portion in which a part of the second member is raised to a position higher than the second front surface with respect to the welding bottom surface on a radially outer side of the welding bottom surface.

The present disclosure can provide a welded body, a method for friction stir spot welding, and a friction stir spot welding device capable of reducing occurrence of an unstable interface fracture and controlling a plug fracture as a fracture mode.

### BRIEF DESCRIPTION OF DRAWINGS

FIG. 1 is a schematic diagram illustrating a configuration of a friction stir spot welding device of the present disclosure.

FIG. 2 is a diagram illustrating a shoulder advance process of press-fitting a shoulder into an overlapping portion of a welding member in advance in a case where a tool for friction stir spot welding is used.

FIG. 3 is a diagram illustrating a step chart of a method for friction stir spot welding according to an embodiment of the present disclosure.

FIG. 4 is a schematic sectional view for describing an anchor, a hooking, and an indent of a welded body according to an embodiment of the present disclosure.

FIG. 5 is a schematic sectional view illustrating arrangement of a pin and a shoulder when an indent of a welded body according to an embodiment of the present disclosure is formed.

FIG. 6 is a schematic sectional view for describing a fracture mode of the welded body.

FIG. 7 is an image of a state in which an upper plate and a lower plate are peeled off in a case where an interface fracture occurs in the welded body.

FIG. 8 is an image of a state in which the upper plate and the lower plate are peeled off in a case where a plug fracture occurs in the welded body.

FIG. 9 is a graph illustrating a relationship between a welding time and a shoulder pushing amount in a method for friction stir spot welding according to an embodiment of the present disclosure.

FIG. 10 is a graph illustrating a relationship between an anchor height and a tensile strength in the welded body of the present disclosure.

FIG. 11 is a graph illustrating a relationship between the anchor height and the fracture mode in the welded body of the present disclosure.

FIG. 12 is a graph illustrating a relationship between a hooking height and the fracture mode in the welded body of the present disclosure.

FIG. 13 is a graph illustrating a relationship between a press-fitting amount of the shoulder into the lower plate and the anchor height in the welded body of the present disclosure.

FIG. 14 is a graph illustrating a relationship between the press-fitting amount of the shoulder into the lower plate and the hooking height in the welded body of the present disclosure.

FIG. 15 is a sectional image illustrating the anchor height and the hooking height in a case where the press-fitting amount of the shoulder is changed in the welded body of the present disclosure.

FIG. 16 is a graph illustrating a relationship between an effective distance and the fracture mode in the welded body of the present disclosure.

FIG. 17 is a graph illustrating a relationship between displacement and a load when a tensile shear test is performed on the welded body.

FIG. 18 is a sectional image illustrating a fractured state of the welded body corresponding to the graph illustrated in FIG. 17.

FIG. 19 is a graph illustrating a relationship between the anchor height and the fracture mode in the welded body of the present disclosure.

### DESCRIPTION OF EMBODIMENTS

Hereinafter, embodiments of the present disclosure will be described in detail with reference to the drawings. A method for friction stir spot welding of the present disclosure can be applied to manufacturing of various welded bodies obtained by overlapping and spot-welding two or more structural members such as a metal plate, a frame, an exterior member, or a columnar member. The welded body to be manufactured is, for example, a constituent member of a structure such as an aircraft, a railway vehicle, or an automobile.

### [Configuration of Friction Stir Spot Welding Device]

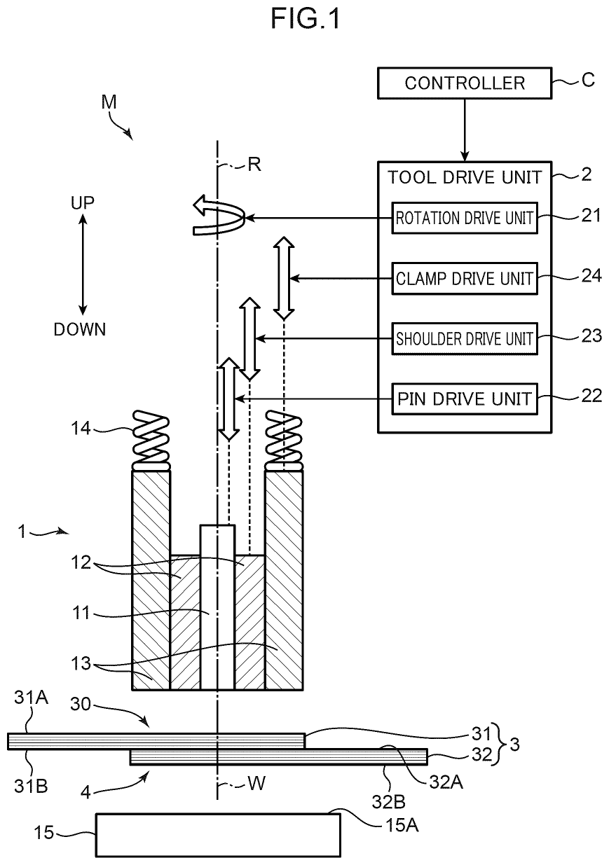

FIG. 1 is a schematic diagram illustrating a configuration of a friction stir spot welding device M according to an embodiment of the present disclosure. The friction stir spot welding device M softens an upper plate 31 and a lower plate 32 by frictional heat to weld the plates together. The friction stir spot welding device M includes a tool 1 for friction stir spot welding, a tool drive unit 2 that rotates and lifts and lowers the tool 1, and a controller C that controls an operation of the tool drive unit 2. In FIG. 1, directions “up” and “down” are indicated for convenience of description, and are not intended to limit an actual direction for use of the tool 1.

The tool 1 is supported by a tool fixing portion. The tool fixing portion can be, for example, a distal end of an articulated robot. A backup 15 is disposed to face a lower end surface of the tool 1. At least two metal members as welding targets are disposed between the tool 1 and the backup 15. FIG. 1 illustrates an example in which an overlapping portion 30 in which a part of the upper plate 31 including a flat plate and a part of the lower plate 32 also including a flat plate overlap each other in an up-down direction is disposed between the tool 1 and the backup 15. Note that the tool 1 corresponds to a welding tool of the present disclosure.

The tool 1 includes a pin 11 extending along a predetermined axial direction, a shoulder 12, a clamp 13, and a spring 14. The pin 11 has a columnar shape, and is disposed to have a central axis that extends in the up-down direction. The pin 11 is rotatable about the axis as a rotation axis R, and is able to ascend and descend, that is, proceed and recede along the rotation axis R in the up-down direction. When the tool 1 is used, the rotation axis R and a spot welding position W in the overlapping portion 30 are aligned. The tool 1 is a double-acting tool in which the pin 11 and the shoulder 12 move independently.

The shoulder 12 includes a hollow portion into which the pin 11 is inserted, and is a member having a cylindrical shape. The axis of the shoulder 12 is coaxial with the axis of the pin 11 which is the rotation axis R. The shoulder 12 rotates about the rotation axis R and ascends and descends, that is, proceeds and recedes along the rotation axis R in the up-down direction. Both the shoulder 12 and the pin 11 inserted into the hollow portion relatively move in the direction of the rotation axis R while rotating about the rotation axis R. That is, the pin 11 and the shoulder 12 not only simultaneously ascend and descend along the rotation axis R, but also independently move such that one of the pin 11 or the shoulder 12 descends and the other ascends.

The clamp 13 includes a hollow portion into which the shoulder 12 is inserted, and is a member having a cylindrical shape. The axis of the clamp 13 is also coaxial with the rotation axis R. The clamp 13 does not rotate about the rotation axis R but ascends and descends, that is, proceeds and recedes along the rotation axis R in the up-down direction. The clamp 13 serves to surround an outer periphery of the pin or the shoulder 12 when the pin 11 or the shoulder performs friction stir. By the clamp 13 surrounding the outer periphery, a friction stir spot welded portion can be finished smoothly without scattering a friction stir material.

The spring 14 is attached to an upper end side of the clamp 13 and biases the clamp 13 downward in a direction toward the overlapping portion 30. The clamp 13 is attached to the tool fixing portion via the spring 14. The backup 15 includes a support surface 15A (FIG. 1) that supports a lower surface side of a welding target (overlapping portion 30). The backup 15 is a backing member that supports the overlapping portion 30 when the pin 11 or the shoulder 12 is press-fitted into the overlapping portion 30. The clamp 13 biased by the spring 14 presses the overlapping portion 30 against the backup 15.

The tool drive unit 2 includes a rotation drive unit 21, a pin drive unit 22, a shoulder drive unit 23, and a clamp drive unit 24. The rotation drive unit 21 includes a motor, a drive gear, and the like, and rotatably drives the pin 11 and the shoulder 12 about the rotation axis R. The rotation drive unit 21 corresponds to a rotation mechanism of the present disclosure. The pin drive unit 22 is a mechanism that causes the pin 11 to proceed and recede, that is, ascend and descend along the rotation axis R. The pin drive unit 22 drives the pin 11 to be press-fitted into the overlapping portion 30 and to be retracted from the overlapping portion 30. The shoulder drive unit 23 is a mechanism that causes the shoulder 12 to proceed and recede along the rotation axis R, and causes the shoulder 12 to be press-fitted into and retracted from the overlapping portion 30. Note that the pin drive unit 22 and the shoulder drive unit 23 correspond to a movement mechanism of the present disclosure capable of independently moving the pin 11 and the shoulder 12 in the axial direction in which the central axis extends. The clamp drive unit 24 is a mechanism that causes the clamp 13 to proceed and recede along the rotation axis R. The clamp drive unit 24 moves the clamp 13 toward the overlapping portion 30 and presses the overlapping portion 30 against the backup 15. At this time, a biasing force of the spring 14 acts.

The controller C includes a microcomputer or the like, and controls the operation of each part of the tool drive unit 2 by executing a predetermined control program. Specifically, the controller C controls the rotation drive unit 21 to cause the pin 11 and the shoulder 12 to perform a required rotation operation. In addition, the controller C controls the pin drive unit 22, the shoulder drive unit 23, and the clamp drive unit 24 to cause the pin 11, the shoulder 12, and the clamp 13 to perform a required proceeding and retracting operation. The controller C corresponds to a control unit of the present disclosure.

### [Method of Using Tool]

Next, a method of using the tool 1 exemplified in the present embodiment will be described. As a method of using the friction stir spot welding device M, there are roughly a pin advance process of press-fitting the pin 11 of the tool 1 into the overlapping portion of a welding member in advance and a shoulder advance process of first press-fitting the shoulder 12 into the overlapping portion of the welding member in advance. Among the processes, in the present embodiment, the shoulder advance process is adopted.

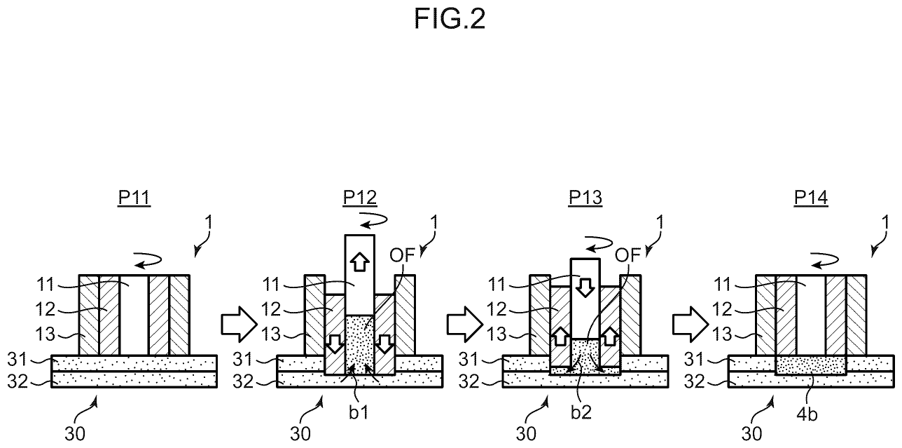

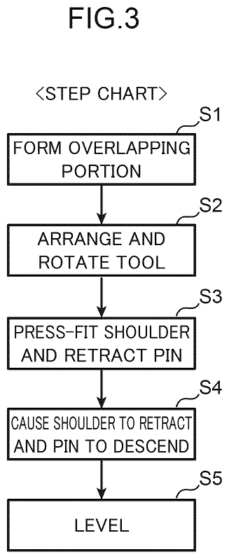

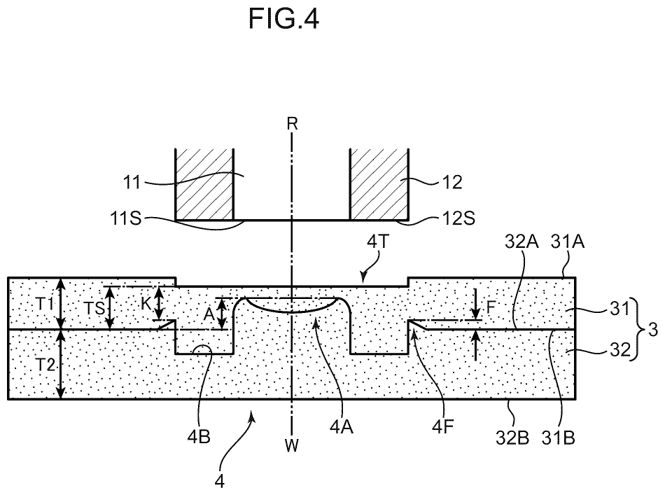

FIG. 2 illustrates processes P11 to P14 of a method for friction stir spot welding by the shoulder advance process. FIG. 3 is a diagram illustrating a step chart of a method for friction stir spot welding according to the present embodiment. FIG. 3 schematically illustrates a process of friction stir spot welding of the overlapping portion 30 between the upper plate 31 and the lower plate 32. FIG. 4 is a schematic sectional view for describing an anchor, a hooking, and an indent of a welded body 3 according to the present embodiment.

The upper plate 31 includes metal, and has an upper plate front surface 31A and an upper plate back surface 31B (FIG. 1). The upper plate front surface 31A is a surface of the upper plate 31, and corresponds to an upper surface of the upper plate 31 in FIG. 1. Similarly, the upper plate back surface 31B is a back surface of the upper plate 31 and corresponds to a lower surface of the upper plate 31 in FIG. 1. The upper plate front surface 31A corresponds to a first front surface of the present disclosure, and the upper plate back surface 31B corresponds to a first back surface of the present disclosure. As an example, the upper plate 31 includes an aluminum alloy. The upper plate 31 may be a wrought material or a cast metal. The upper plate 31 may be subjected to chemical conversion treatment, electrodeposition coating, or the like.

The lower plate 32 includes metal, and has a lower plate front surface 32A and a lower plate back surface 32B (FIG. 1). The lower plate front surface 32A is a surface of the lower plate 32, and corresponds to an upper surface of the lower plate 32 in FIG. 1. Similarly, the lower plate back surface 32B is a back surface of the lower plate 32, and corresponds to a lower surface of the lower plate 32 in FIG. 1. The lower plate front surface 32A corresponds to a second front surface of the present disclosure, and the lower plate back surface 32B corresponds to a second back surface of the present disclosure. As an example, the lower plate 32 includes high-tensile steel. The lower plate 32 may include mild steel or hot stamped steel. The lower plate 32 may be subjected to non-plating treatment, zinc plating treatment, Al—Si plating treatment, chemical conversion treatment, electrodeposition coating, or the like. An adhesive or a sealing material may be interposed between the upper plate 31 and the lower plate 32. As described above, since the upper plate 31 includes an aluminum alloy and the lower plate 32 includes a high-tensile steel, the melting point of the upper plate 31 is set to be lower than the melting point of the lower plate 32.

In performing friction stir spot welding, first, the overlapping portion 30 is formed by the upper plate 31 and the lower plate 32 (step S1 in FIG. 3). In the overlapping portion 30, at least a part of the lower plate front surface 32A abuts on the upper plate back surface 31B, and the upper plate 31 and the lower plate 32 are disposed to overlap each other.

Next, the tool 1 is disposed at a predetermined position and rotated (step S2 in FIG. 3). Specifically, first, the tool 1 is disposed to face the overlapping portion 30 such that the rotation axis R of the tool 1 is parallel to an overlapping direction of the upper plate 31 and the lower plate 32, that is, the up-down direction. In this form of facing arrangement, the rotation axis R of the tool 1 may be inclined with respect to the up-down direction. In the present embodiment, the lower end surface of the tool 1 abuts on the upper plate front surface 31A of the upper plate 31 in a state where the rotation axis R is aligned with the predetermined spot welding position W. The clamp 13 presses the overlapping portion 30 against the backup 15 (FIG. 1) with the biasing force of the spring 14. In this manner, in a state where the lower end surface of the tool 1 is in contact with the upper plate front surface 31A of the upper plate 31, the controller C controls the rotation drive unit 21 to rotate the pin 11 and the shoulder 12 about the rotation axis R at a predetermined rotation speed (process P11 in FIG. 2). By this rotation, the region of the overlapping portion 30 where the pin 11 and the shoulder 12 are in contact with each other is preheated by friction. That is, the process P11 in FIG. 2 illustrates a step of preheating the overlapping portion 30.

Next, a press-fitting process in which the shoulder 12 is press-fitted into the overlapping portion 30 in a state where the pin 11 is retracted from the overlapping portion 30 is performed (the process P12 in FIG. 2 and step S3 in FIG. 3). In this step, while maintaining the rotation of the tool 1, the controller C controls the shoulder drive unit 23 to cause the shoulder 12 to descend as indicated by a hollow arrow of the process P12 in FIG. 2 and press-fit the shoulder 12 into the overlapping portion 30, and controls the pin drive unit 22 to ascend, that is, retract the pin 11 as indicated by the hollow arrow. The clamp 13 is immovable. The shoulder 12 is press-fitted to a press-fitting position deeper than the lower plate front surface 32A with respect to the upper plate front surface 31A in the overlapping portion 30 (FIG. 2). As a result, a welding bottom surface 4B (FIG. 4) to be described later is formed. By this operation, as indicated by an arrow b1 in FIG. 2, a material of a press-fitting region of the shoulder 12 is stirred, and an overflowing material OF overflowing from the overlapping portion 30 by the press-fitting is released to a hollow space of the shoulder 12 generated by the retraction of the pin 11. As a result, a base of an anchor 4A (FIG. 4) to be described later and a hooking 4F to be described later are formed. In the press-fitting step, a pressing force, that is, a press-fitting pressing force is applied to all of the pin 11, shoulder 12, and clamp 13 along the axial direction. Meanwhile, a pressing force for pressing the clamp 13 against the backup 15 is applied to the clamp 13. As a result, the pressing force by which the tool 1 is pushed toward the welded body 3 corresponds to a force obtained by subtracting the pressing force of the clamp from the press-fitting pressing force.

Next, while maintaining the rotation of the tool 1, the controller C controls the shoulder drive unit 23 to retract the shoulder 12 from the press-fitting position as indicated by a hollow arrow of the process P13 in FIG. 2, and controls the pin drive unit 22 to cause the pin 11 to descend so as to enter the overlapping portion 30 as indicated by the hollow arrow (the process P13 in FIG. 2 and step S4 in FIG. 3). This step illustrates a backfilling step of the overflowing material OF. In this step, the controller C controls the shoulder drive unit 23 to cause the shoulder 12 to ascend, and controls the pin drive unit 22 to cause the pin 11 to descend. As the pin 11 descends, as indicated by an arrow b2, the overflowing material OF released into the hollow space is backfilled in the press-fitting region of the shoulder 12.

Next, a leveling step of leveling the overlapping portion 30 is performed (the process P14 in FIG. 2 and step S5 in FIG. 3). In this step, the controller C controls the pin drive unit and the shoulder drive unit to rotate both the pin drive unit 22 and the shoulder drive unit 23 in a state where a lower end surface of the pin 11 and a lower end surface of the shoulder 12 are disposed at positions lower than the upper plate front surface 31A of the upper plate 31 to smooth the spot welded portion. As a result, an indent 4T (FIG. 4) to be described later is formed. By the above process, a stir-welded portion 4 (FIG. 1) in which the upper plate 31 and the lower plate 32 are welded to each other is formed. The stir-welded portion 4 corresponds to a welded portion of the present disclosure.

### [Structure of Welded Body]

The stir-welded portion 4 of the welded body 3 formed by friction stir spot welding as described above has a welding bottom surface 4B, the anchor 4A, the hooking 4F, and the indent 4T.

The welding bottom surface 4B is an interface of the upper plate 31 and the lower plate 32 which is generated at a position deeper than the lower plate front surface 32A with respect to the upper plate front surface 31A by being pressed by the shoulder 12. When viewed along the rotation axis R, the welding bottom surface 4B has a ring shape corresponding to a shoulder lower surface 12S of the shoulder 12. Note that the ring shape is not limited to a shape including two perfect circles, and may be deformed depending on the conditions of friction stir spot welding. In other words, the welding bottom surface 4B has a substantially ring shape in plan view.

The anchor 4A is a raised portion in which a part of the lower plate 32 is raised to a position higher than the lower plate front surface 32A with respect to the welding bottom surface 4B on a radially inner side of the welding bottom surface 4B. The anchor 4A is formed by crushing an upper end of the overflowing material OF overflowing from the overlapping portion 30 into the hollow space of the shoulder 12 in the press-fitting step by the pin 11 in the backfilling step. The anchor 4A corresponds to an inner raised portion of the present disclosure.

The hooking 4F is a raised portion in which a part of the lower plate 32 is raised to a position higher than the lower plate front surface 32A with respect to the welding bottom surface 4B on a radially outer side of the welding bottom surface 4B. As described above, in the press-fitting step, the overflowing material OF of the lower plate 32 overflows into the hollow space of the shoulder 12, but also on a radially outer side of the shoulder 12, a part of the lower plate 32 is pushed up by the press-fitting of the shoulder 12, and the hooking 4F is formed. The hooking 4F corresponds to an outer raised portion of the present disclosure.

The indent 4T is disposed to face the welding bottom surface 4B and the anchor 4A in the overlapping direction of the upper plate 31 and the lower plate 32, that is, in the up-down direction, and corresponds to a recessed portion in which a part of the upper plate front surface 31A of the upper plate 31 is recessed.

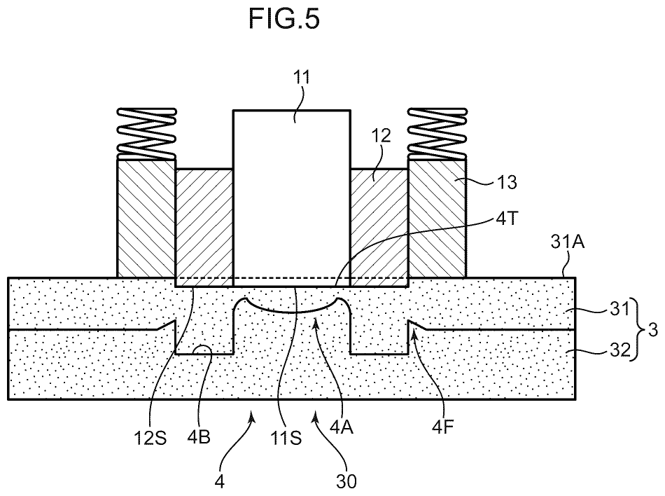

FIG. 5 is a schematic sectional view illustrating arrangement of the pin 11 and the shoulder 12 when the indent of the welded body 3 according to the present embodiment is formed. In the present embodiment, the shoulder 12 is retracted from the press-fitting position while being rotated after the formation of the welding bottom surface 4B, and in the leveling step (the process P14 in FIG. 2 and step S5 in FIG. 3), as illustrated in FIG. 5, the controller C arranges a pin lower surface 11S of the pin 11 and the shoulder lower surface 12S of the shoulder 12 at a position at the upper plate back surface 31B side relative to the upper plate front surface 31A. Thus, the indent 4T can be formed at an arbitrary position in the stir-welded portion 4. The shoulder lower surface 12S corresponds to a distal end surface of the shoulder 12.

As described above, in the present embodiment, the controller C of the friction stir spot welding device M welds the upper plate 31 and the lower plate 32 while controlling the tool drive unit 2 so as to form the anchor 4A, the welding bottom surface 4B, the hooking 4F, and the indent 4T in the stir-welded portion 4.

The definition of each characteristic value in the stir-welded portion 4 will be described with reference to FIG. 4 again. In the overlapping direction (up-down direction) of the upper plate 31 and the lower plate 32, a thickness of the upper plate 31 is defined as an upper plate thickness T1, and a thickness of the lower plate 32 is defined as a lower plate thickness T2. A distance from a top of the hooking 4F to a bottom of the indent 4T in the overlapping direction is defined as an effective distance K. A distance from the lower plate front surface 32A to a top of the anchor 4A in the overlapping direction is defined as an anchor height A. The anchor height A corresponds to a height of an inner raised portion of the present disclosure. Furthermore, a distance from the upper plate back surface 31B to the bottom of the indent 4T in the overlapping direction is defined as a reference distance TS. A distance from the upper plate back surface 31B to the top of the hooking 4F in the overlapping direction is defined as a hooking height F.

### <Claims 1, 6, and 8>

### Operation and Effect

The welded body 3, the method for friction stir spot welding, and the friction stir spot welding device M according to the present embodiment exhibit the following operation and effect.

In the present embodiment, the stir-welded portion 4 to which the upper plate 31 and the lower plate 32 are welded has the welding bottom surface 4B, the anchor 4A, the hooking 4F, and the indent 4T. By the formation of the welding bottom surface 4B by the shoulder 12, a part of the upper plate 31 is disposed to be wedged into a portion below the upper plate back surface 31B (lower plate front surface 32A). On the radially inner side of the welding bottom surface 4B, a part of the lower plate 32 is disposed as the anchor 4A so as to be raised above the upper plate back surface 31B. Furthermore, on the radially outer side of the welding bottom surface 4B, a part of the lower plate 32 is disposed as the hooking 4F so as to be raised above the upper plate back surface 31B. As a result, the upper plate 31 and the lower plate 32 are wedged into each other, and the upper plate 31 and the lower plate 32 are firmly welded to each other to enhance strength of the upper plate 31 and the lower plate 32.

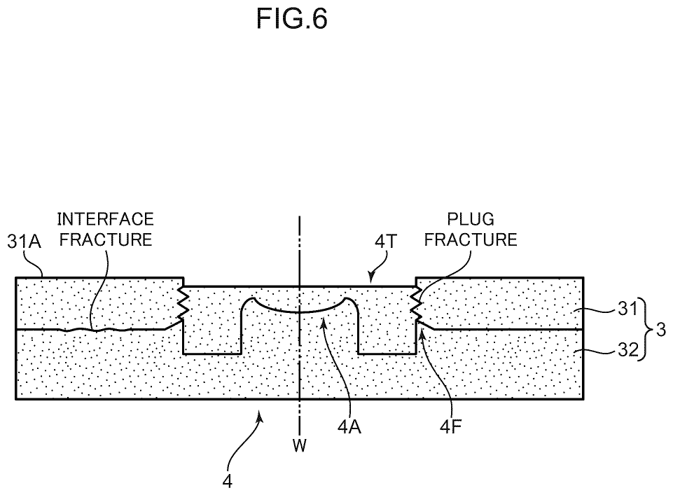

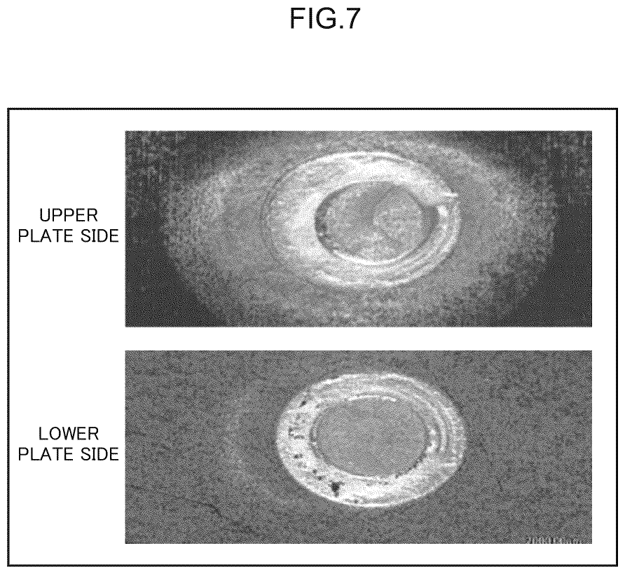

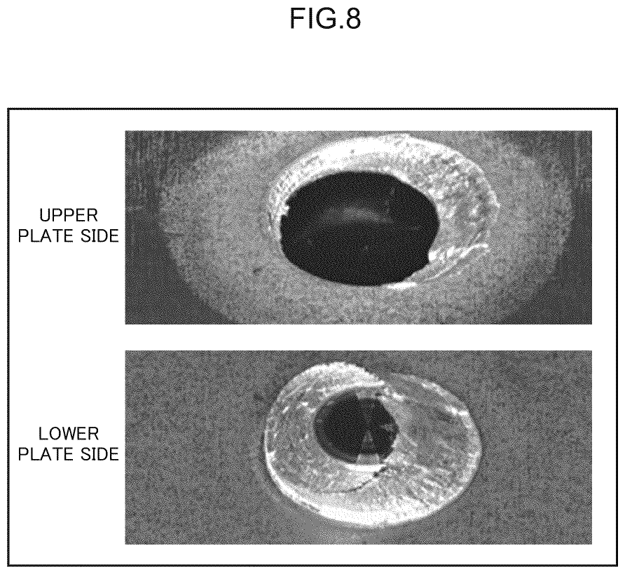

In such a welded body 3, a fracture may rarely occur due to sudden or temporal change. FIG. 6 is a schematic sectional view for describing the fracture mode of the welded body 3. A plug fracture is a fracture that occurs along the overlapping direction of the upper plate 31 and the lower plate 32, and an interface fracture is a fracture that occurs along the interface of the upper plate 31 and the lower plate 32. FIG. 7 is an image of the stir-welded portion 4 in a state where the upper plate 31 and the lower plate 32 are peeled off when the interface fracture is intentionally generated in the welded body 3. FIG. 8 is an image of the stir-welded portion 4 in a state where the upper plate 31 and the lower plate 32 are peeled off when the plug fracture occurs in the welded body 3.

In the present embodiment, as illustrated in FIG. 6, by the formation of the indent 4T above the welding bottom surface 4B, a cross section of the upper plate front surface 31A becomes discontinuous, and a weakest portion can be intentionally disposed between an end (corner) of the indent 4T and the top of the hooking 4F. Therefore, even if a fracture occurs in the stir-welded portion 4 due to some sudden or temporal cause after the manufacture of the welded body 3, the occurrence of a plug fracture can be prioritized by concentrating a stress on the weakest portion, and the occurrence of interface fracture can be suppressed. Furthermore, in the present embodiment, since the anchor 4A and the hooking 4F are wedged toward the upper plate 31, an unstable interface fracture at the interface of the upper plate 31 and the lower plate 32 as illustrated in FIG. 7 can be prevented, and the plug fracture as illustrated in FIG. 8 can be stably obtained. Therefore, it is possible to visually recognize the occurrence of a fracture in the stir-welded portion 4 from the outside, and it is possible to easily and quickly find and deal with the fracture.

In the present embodiment, in the leveling step described above, the pin lower surface 11S of the pin 11 and the shoulder lower surface 12S of the shoulder 12 are disposed at a position between the upper plate front surface 31A and the upper plate back surface 31B, specifically, near the upper plate front surface 31A. Therefore, the indent 4T can be reliably and stably formed in the stir-welded portion 4.

In the present embodiment, it is desirable that the effective distance K is 77.0% or less of the reference distance TS as described in detail in Examples described later. In this case, by further concentrating the stress on the weakest portion between the end (corner) of the indent 4T and the top of the hooking 4F, the occurrence of the plug fracture can be prioritized and the occurrence of the interface fracture can be suppressed.

The anchor height A is preferably 55.3% or more and less than 100% of the reference distance TS. In this case, the upper plate 31 and the lower plate 32 are firmly welded to each other to enhance strength of the upper plate 31 and the lower plate 32. In addition, the unstable interface fracture at the interface of the upper plate 31 and the lower plate 32 can be further prevented, and the plug fracture can be stably obtained.

Furthermore, in the present embodiment, the upper plate 31 and the lower plate 32 are used in which the melting point of the upper plate 31 is lower than the melting point of the lower plate 32. In this case, since a part of the lower plate 32 can be wedged into a higher position of the upper plate 31 having a relatively low melting point by friction stir spot welding, the anchor 4A and the hooking 4F can be formed more stably.

### EXAMPLES

Next, the welded body, the method for friction stir spot welding, and the friction stir spot welding device of the present disclosure will be described in more detail with Examples. Note that the present disclosure is not limited to these Examples.

### <Formation of Indent>

In the method for friction stir spot welding of the present disclosure, a confirmation experiment was conducted on the formation of the indent. Experimental condition 1 of the experiment is illustrated below.

### (Experimental Condition 1)

Outer diameter of pin 11: 3 mm, outer diameter of shoulder 12: 5 mm, pressing load of clamp 13 (pressing force of clamp): 7 kN, rotation speed of tool 1: 2000 rpm, and pressing force when shoulder 12 is press-fitted (press-fitting pressing force): 13 kN.
Upper plate 31: 6000 series aluminum alloy having upper plate thickness T1 of 1.1 mm, and lower plate 32: 1.2 GPa-class ultra high tensile strength steel having lower plate thickness T2 of 1.2 mm.
Anchor height A/reference distance TS: 55.3% to 95.7%. Anchor height A/upper plate thickness T1: 40% to 80%.

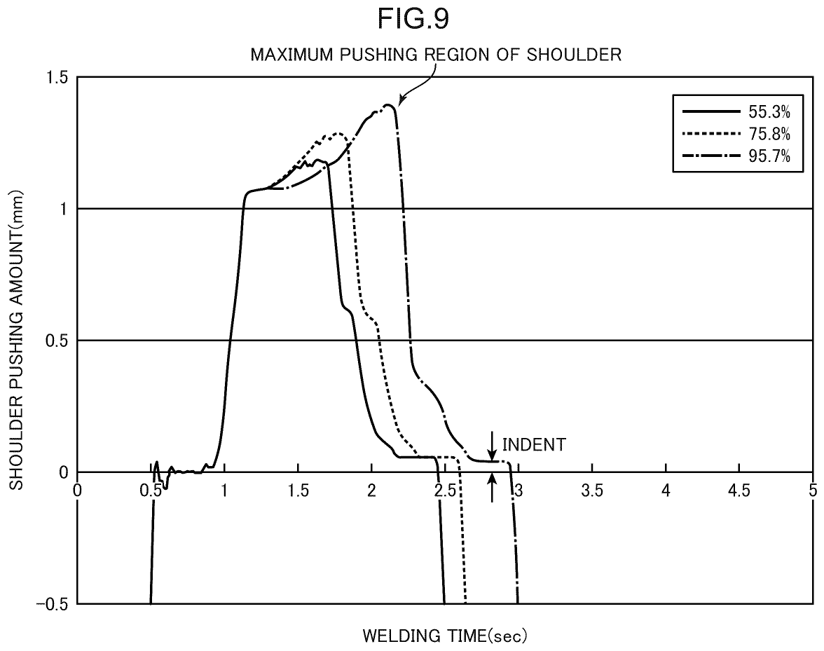

FIG. 9 is a graph illustrating a relationship between a welding time and a shoulder pushing amount in the above experiment. In a vertical axis in FIG. 9, the position of the upper plate front surface 31A of the upper plate 31 is set to 0, and the pushing amount of the shoulder is illustrated. The welding time on a horizontal axis includes an air cutting step of bringing the tool 1 close to the overlapping portion 30 as preparation for a welding work, and thus the actual welding work is started at around 0.5 sec in FIG. 9. Note that FIG. 9 illustrates data under three conditions in which the anchor 4A height is different, and illustrates results under three conditions of 55.3%, 75.8%, and 95.7% as a ratio of the anchor height A to the reference distance TS described above.

In any data in FIG. 9, the shoulder 12 is pushed from the upper plate front surface 31A at around one second after the start of the welding work, pushed to a maximum pushing position, that is, the press-fitting position, and then retracted from the press-fitting position. Then, it was confirmed that the indent 4T is formed by performing the above leveling step at a position between the upper plate front surface 31A and the upper plate back surface 31B, that is, a position where the amount of pushing to the upper plate front surface 31A is about 0.05 mm in FIG. 9.

### <Relationship Between Anchor Height and Fracture Mode>

Next, the welded bodies 3 having different anchor heights were manufactured, and the fracture mode occurring in each of the welded bodies 3 was evaluated. The experimental condition was the same as Experimental condition 1 described above. By performing a tensile test in accordance with JISZ3136 on the welded body 3, it was confirmed whether any of a plug fracture or an interface fracture occurs. Tables 1 to 5 show the tensile strengths and the identified fracture mode for the anchor height A/the reference distance TS expressed in percent. Note that, in each table, each number in parentheses indicates the anchor height A/the upper plate thickness T1 in percent.

TABLE 1

| A/TS (A/T1)% | Tensile strength (kN) | Fracture mode |
|---|---|---|
| 0(0) | 2.67 | Interface |
| 0(0) | 2.61 | Interface |
| 0(0) | 2.76 | Plug |
| 0(0) | 2.79 | Plug |
| 0(0) | 2.71 | Plug |
| 0(0) | 2.68 | Plug |
| 0(0) | 2.72 | Plug |
| 0(0) | 2.77 | Plug |
| 0(0) | 2.68 | Plug |
| 0(0) | 2.67 | Plug |

TABLE 2

| A/TS (A/T1)% | Tensile strength (kN) | Fracture mode |
|---|---|---|
| 34.4(20) | 2.82 | Interface |
| 34.4(20) | 2.82 | Plug |
| 34.4(20) | 2.72 | Plug |
| 34.4(20) | 2.79 | Plug |
| 34.4(20) | 2.76 | Plug |
| 34.4(20) | 2.79 | Plug |
| 34.4(20) | 2.82 | Plug |
| 34.4(20) | 2.85 | Plug |
| 34.4(20) | 2.85 | Interface |
| 34.4(20) | 2.85 | Plug |

TABLE 3

| A/TS (A/T1)% | Tensile strength (kN) | Fracture mode |
|---|---|---|
| 55.3(40) | 2.72 | Plug |
| 55.3(40) | 3.01 | Plug |
| 55.3(40) | 2.91 | Plug |
| 55.3(40) | 2.69 | Plug |
| 55.3(40) | 2.92 | Plug |
| 55.3(40) | 2.88 | Plug |
| 55.3(40) | 2.85 | Plug |
| 55.3(40) | 2.94 | Plug |
| 55.3(40) | 2.72 | Plug |
| 55.3(40) | 3.12 | Plug |

TABLE 4

| A/TS (A/T1)% | Tensile strength (kN) | Fracture mode |
|---|---|---|
| 75.8(60) | 2.68 | Plug |
| 75.8(60) | 2.86 | Plug |
| 75.8(60) | 2.87 | Plug |
| 75.8(60) | 3.30 | Plug |
| 75.8(60) | 3.15 | Plug |
| 75.8(60) | 3.01 | Plug |
| 75.8(60) | 3.02 | Plug |
| 75.8(60) | 3.12 | Plug |
| 75.8(60) | 3.23 | Plug |
| 75.8(60) | 2.99 | Plug |

TABLE 5

| A/TS (A/T1)% | Tensile strength (kN) | Fracture mode |
|---|---|---|
| 95.7(80) | 2.74 | Plug |
| 95.7(80) | 2.83 | Plug |
| 95.7(80) | 2.86 | Plug |
| 95.7(80) | 2.72 | Plug |
| 95.7(80) | 2.81 | Plug |
| 95.7(80) | 2.81 | Plug |
| 95.7(80) | 2.84 | Plug |
| 95.7(80) | 2.68 | Plug |
| 95.7(80) | 2.69 | Plug |
| 95.7(80) | 2.80 | Plug |

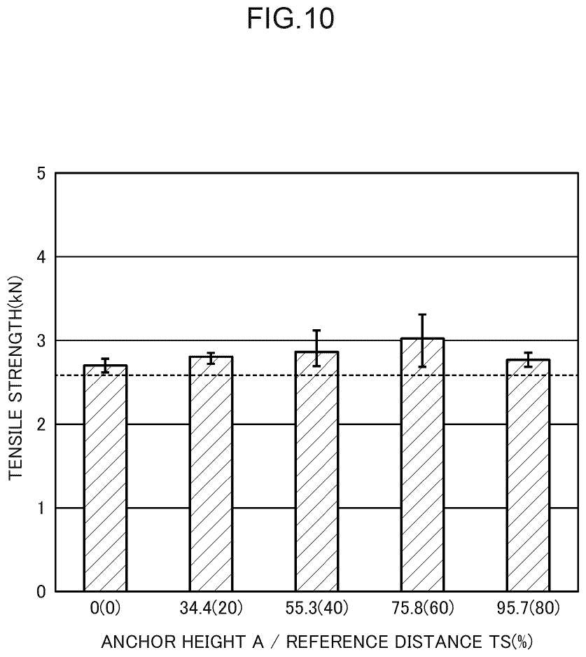

FIG. 10 is a graph illustrating the relationship between the ratio of the anchor height A to the reference distance TS and the tensile strength on the basis of results shown in Tables 1 to 5. In the graph, an average value of the tensile strength under each condition of A/TS is indicated by a bar graph, and a variation is indicated by an I chart. As indicated by a broken line in FIG. 10, a lower limit value of the tensile strength is substantially constant regardless of the value of A/TS, and it has been confirmed that a large decrease in strength does not occur even when the anchor height A/the reference distance TS increases.

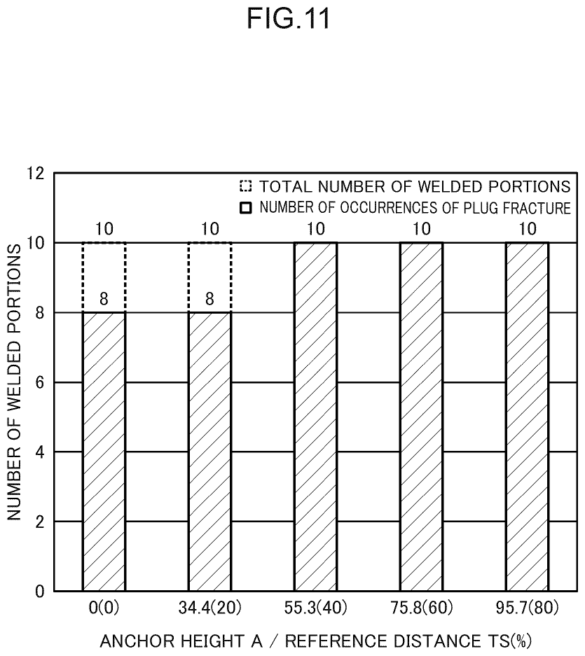

FIG. 11 is a graph illustrating the relationship between the ratio of the anchor height A to the reference distance TS and the fracture mode on the basis of the results shown in Tables 1 to 5. In FIG. 11, the horizontal axis represents the ratio of the anchor height A to the reference distance TS, the ratio is expressed in percentage, and the vertical axis represents the number of welded portions in which the fracture mode is identified. Note that, in the horizontal axis in FIG. 11, each number in parentheses indicates the ratio of the anchor height A to the upper plate thickness T1. It has been confirmed that an interface fracture occurs in two often welded portions under the conditions of A/TS of 0 and 34.4, but a plug fracture occurred in all the welded portions under each condition of A/TS of 55.3 or more. As described above, under the condition of A/TS≥55.3, the fracture mode occurring in the stir-welded portion 4 can be controlled to be a plug fracture with high accuracy. While the anchor height A is set relatively high, it is desirable to set the top of the anchor 4A so as not to reach the indent 4T in order to avoid a decrease in strength of the stir-welded portion 4. In the present disclosure, an appropriate anchor 4A and an appropriate indent 4T can be formed by adjusting the press-fitting position and a final position (leveling position) of the shoulder 12.

### <Relationship Between Hooking Height and Fracture Mode>

Next, the welded bodies 3 having different hooking heights were manufactured, and the fracture mode occurring in each of the welded bodies 3 was evaluated. The experimental condition was the same as Experimental condition 1 described above. By performing a tensile test in accordance with JISZ3136 on the welded body 3, it was confirmed whether any of a plug fracture or an interface fracture occurs.

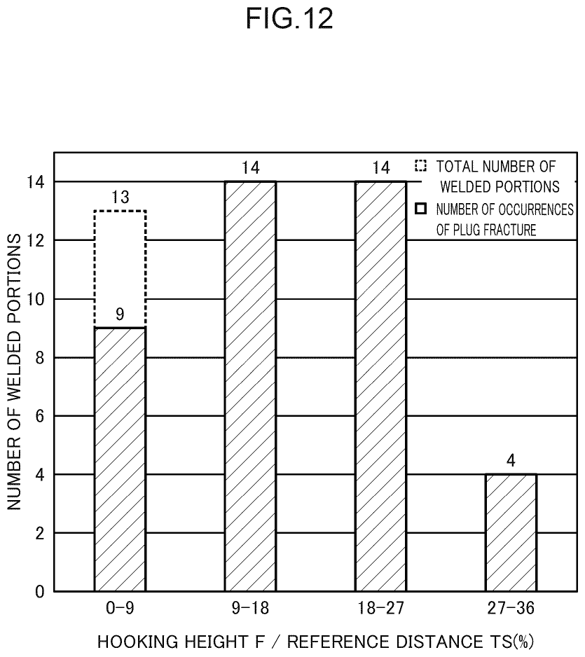

FIG. 12 is a graph illustrating a relationship between a ratio of the hooking height F to the reference distance TS and the fracture mode. In the horizontal axis in FIG. 12, the hooking height F with respect to the reference distance TS is expressed in percentage and classified into four levels, and the vertical axis represents the number of welded portions in which the fracture mode is identified. It has been confirmed that the fracture mode in 4 of 13 welded portions is an interface fracture under the condition of F/TS of 0% to 9, but, all the occurring fracture modes are plug fracture under each condition of F/TS of 9% or more. Therefore, detailed data of each welded portion under the condition of F/TS of 0% to 9% is shown in Table 6 below.

TABLE 6

| Welded | Hooking height F | Hooking height F/ | |
|---|---|---|---|
| portion | (mm) | reference distance TS (%) | Fracture mode |
| 1 | 0.020 | 1.8 | Interface |
| 2 | 0.040 | 3.6 | Plug |
| 3 | 0.050 | 4.5 | Interface |
| 4 | 0.050 | 4.5 | Plug |
| 5 | 0.065 | 5.9 | Plug |
| 6 | 0.065 | 5.9 | Plug |
| 7 | 0.070 | 6.4 | Plug |
| 8 | 0.070 | 6.4 | Plug |
| 9 | 0.075 | 6.8 | Plug |
| 10 | 0.075 | 6.8 | Plug |
| 11 | 0.075 | 6.8 | Interface |
| 12 | 0.085 | 7.7 | Interface |
| 13 | 0.095 | 8.6 | Plug |

From the results of Table 6 and FIG. 12, it has been confirmed that an interface fracture could occur when F/TS is 7.7% or less, but the fracture mode occurring in all the stir-welded portions 4 can be controlled to be a plug fracture under the condition of F/TS≥8.6%. Therefore, the fracture mode occurring in the stir-welded portion 4 can be controlled to be a plug fracture with high accuracy.

### <Relationship Between Anchor, Hooking, and Press-Fitting Amount of Shoulder>

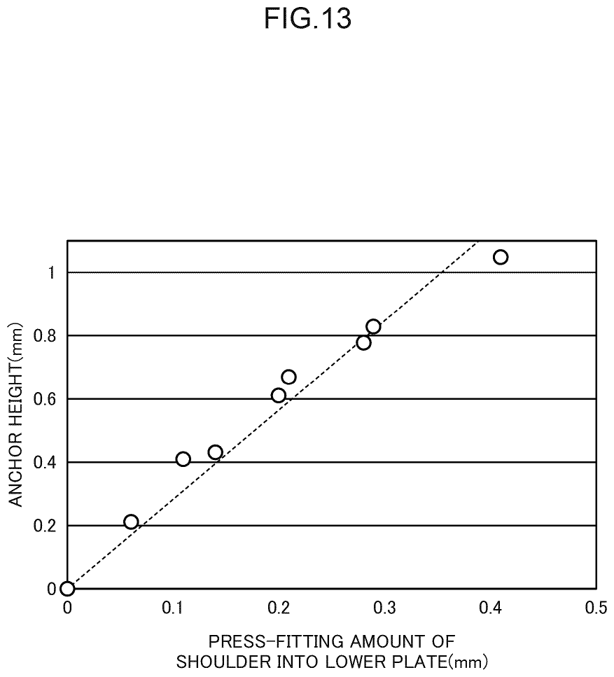

Next, under Experimental condition 1 described above, the press-fitting amount of the shoulder was changed, and the heights of the anchor 4A and the hooking 4F generated were evaluated. FIG. 13 is a graph illustrating a relationship between the press-fitting amount of the shoulder into the lower plate 32 and the anchor height Ain the welded body 3. As illustrated in FIG. 13, it has been confirmed that the height of the anchor 4A increases as the press-fitting amount of the shoulder into the lower plate 32 increases, and the press-fitting amount of the shoulder and the anchor 4A has an upward linear correlation.

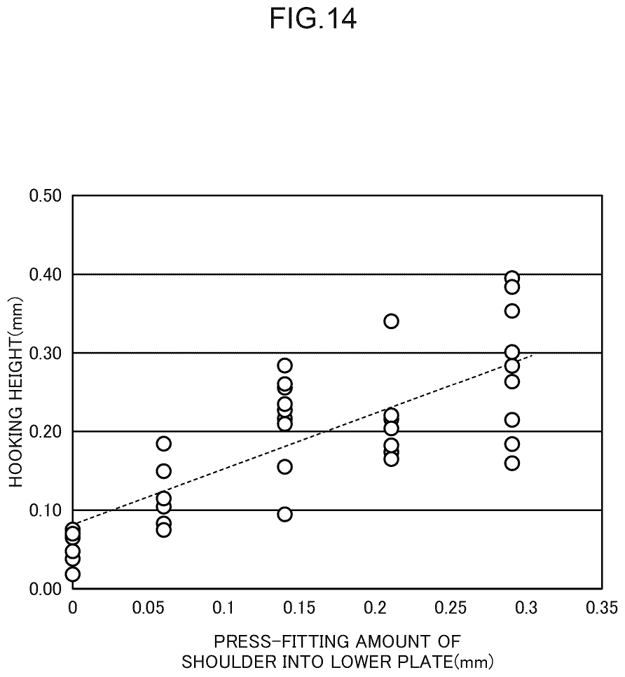

FIG. 14 is a graph illustrating a relationship between the press-fitting amount of the shoulder into the lower plate 32 and the hooking height F. As illustrated in FIG. 14, it has been confirmed that the height of the hooking height F increases as the press-fitting amount of the shoulder into the lower plate 32 increases, and the hooking height F and the press-fitting amount of the shoulder has an upward linear correlation with greater variation than with the anchor 4A.

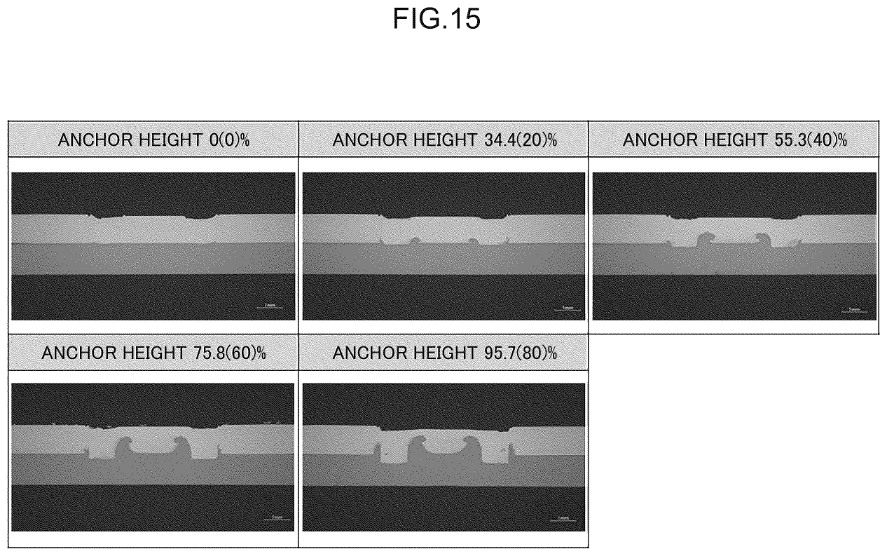

FIG. 15 is a sectional image illustrating how the anchor 4A and the hooking 4F change when the press-fitting amount of the shoulder is changed in each of the above welded bodies 3. As illustrated in FIG. 15, it can be confirmed that the anchor 4A and the hooking 4F rise upward and the anchor height A and the hooking height F increase as the welding bottom surface 4B is located at a deeper position, in other words, as the press-fitting amount of the shoulder is larger.

As described above, it has been confirmed that the anchor height A and the hooking height F can be set to target heights by adjusting the press-fitting amount of the shoulder 12. Note that the anchor height A can be more finely adjusted by the arrangement of the pin 11 and the shoulder 12 in the above leveling step.

<Relationship between Effective Distance and Fracture Mode>

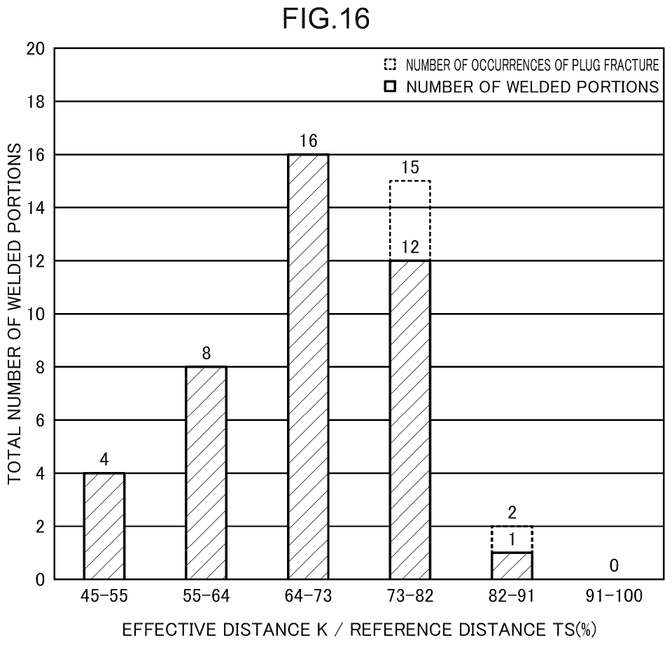

Next, under Experimental condition 1 described above, the relationship between the effective distance K in the welded body 3 and the fracture mode was evaluated. FIG. 16 is a graph illustrating a relationship between a ratio of the effective distance K to the reference distance TS and the fracture mode. In FIG. 16, the horizontal axis represents the ratio, expressed in percentage, of the effective distance K to the reference distance TS, and the vertical axis represents the number of welded portions in which the fracture mode is identified. As illustrated in FIG. 16, under the condition of K/TS of 45% or more and 73% or less, the fracture mode occurring in all the welded bodies 3 was a plug fracture. On the other hand, under the condition of K/TS of 73% or more and 91% or less, an interface fracture is included in the occurring fracture mode. Therefore, detailed data of each welded body 3 under the condition of K/TS of 73% or more and 91% or less is shown in Table 7 below. Table 7 shows 17 target welded bodies 3 in order from the largest K/TS.

TABLE 7

| | Effective | | |
|---|---|---|---|
| Welded | distance K | Effective distance K/ | |
| portion | (mm) | reference distance TS (%) | Fracture mode |
| 1 | 0.93 | 84.4 | Interface |
| 2 | 0.91 | 82.5 | Plug |
| 3 | 0.90 | 81.5 | Interface |
| 4 | 0.88 | 80.4 | Plug |
| 5 | 0.88 | 80.4 | Plug |
| 6 | 0.88 | 80.1 | Plug |
| 7 | 0.88 | 79.7 | Interface |
| 8 | 0.88 | 79.6 | Plug |
| 9 | 0.86 | 78.4 | Plug |
| 10 | 0.86 | 78.1 | Plug |
| 11 | 0.86 | 77.9 | Plug |
| 12 | 0.85 | 77.3 | Interface |
| 13 | 0.85 | 77.0 | Plug |
| 14 | 0.84 | 76.6 | Plug |
| 15 | 0.84 | 76.3 | Plug |
| 16 | 0.83 | 75.7 | Plug |
| 17 | 0.81 | 73.5 | Plug |

As illustrated in FIG. 16 and Table 7, it has been confirmed that the interface fracture occurs partially in a range of K/TS≥77.3%, whereas all the fracture modes occurring in the welded body 3 are plug fracture in a range of K/TS≤77.0%.

### <Evaluation of Progress of Crack>

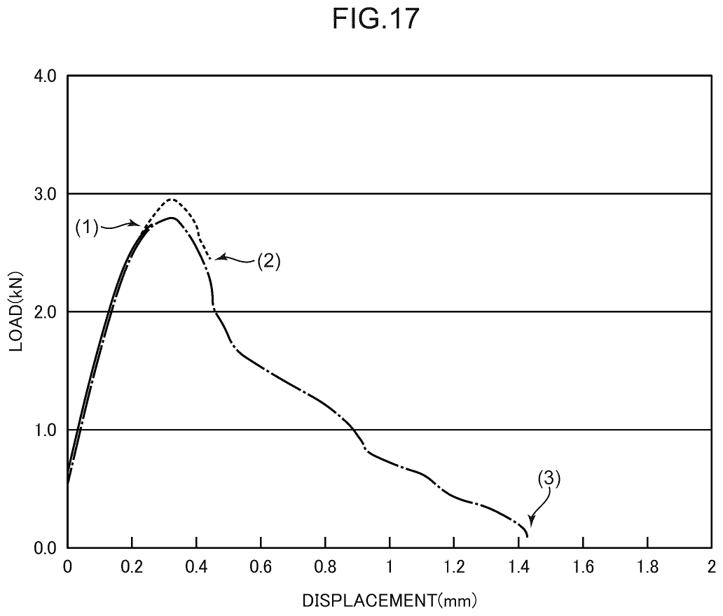

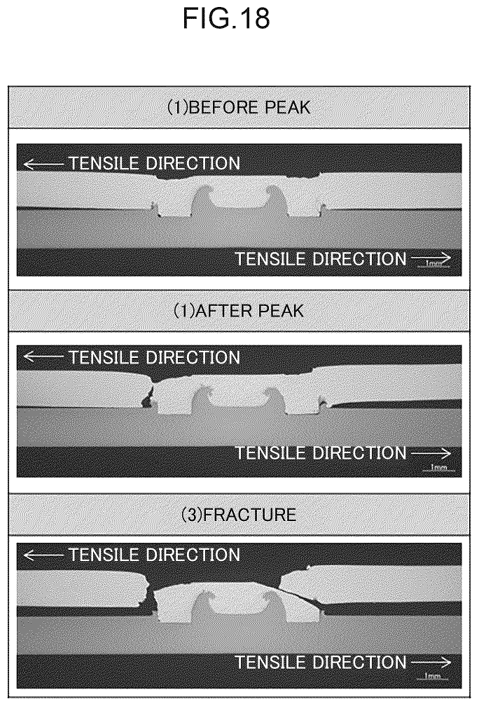

Next, in the welded body 3 in which the fracture mode is controlled to be a plug fracture as described above, a progress of a crack at the time of fracture was evaluated. FIG. 17 is a graph illustrating a relationship between displacement and a load when a tensile shear test in accordance with JISZ3136 is performed on the welded body 3. FIG. 18 is a sectional image illustrating a fractured state of the welded body 3 corresponding to the numbers 1, 2, and 3 in the graph illustrated in FIG. 17. In the tensile shear test, the test was performed on the welded body 3 by applying a load in the right direction to the lower plate 32 and a load in the left direction to the upper plate 31. As illustrated in FIGS. 17 and 18, when the load was increased while displacing the upper plate 31 and the lower plate 32, it has been confirmed that the crack of the plug fracture progresses from “(1) before a peak” to “(2) after the peak”, and it has been also confirmed that the plug fracture completely occurs in the welded body 3 at the subsequent “(3) fracture” stage.

### Results of Different Experimental Conditions

Next, evaluation results of the fracture mode under Experimental condition 2 different from Experimental condition 1 are shown. Experimental condition 2 is as follows.

### (Experimental Condition 2)

Outer diameter of pin 11: 3.25 mm, outer diameter of shoulder 12: 6 mm, pressing load of clamp 13: 6 kN, rotation speed of tool 1: 2000 rpm, and pressing force when shoulder 12 is press-fitted: 13 kN.
Upper plate 31: 6000 series aluminum alloy having upper plate thickness T1 of 1.0 mm, and lower plate 32: 1.2 GPa-class ultra high tensile strength steel having lower plate thickness T2 of 1.0 mm.
Anchor height A/reference distance TS: 0% to 94.0%. Anchor height A/upper plate thickness T1: 0% to 70%.

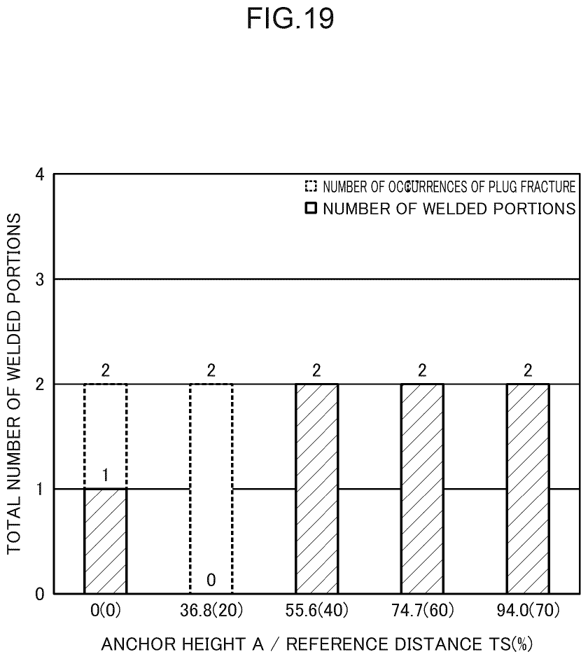

FIG. 19 is a graph illustrating a relationship between a ratio of the anchor height A to the reference distance TS in each welded body 3 and the fracture mode. In FIG. 19, the horizontal axis represents the ratio of the anchor height A to the reference distance TS in percent, and the vertical axis represents the number of welded portions in which the fracture mode is identified. In this evaluation, as illustrated in FIG. 19, it has been confirmed that all the fracture modes occurring in the welded body 3 are plug fracture under the condition of A/TS of 55.6% or more.

Furthermore, Table 8 shows the results of evaluating the fracture mode under Experimental condition 3 different from Experimental conditions 1 and 2.

TABLE 8

| | | | Welding conditions | | | | | | | | | |
|---|---|---|---|---|---|---|---|---|---|---|---|---|
| | | | | | Press- | Press- | | | | | | |
| | Tool dimension | | | | fitting | fitting | Set of plates | | | | | |
| | Shoulder | Pin | Clamp | Rotation | pressing | depth | | Plate | | Plate | Tensile | |
| | diameter | diameter | load | speed | force | (mm) of | Upper | thickness | Lower | thickness | strength | Fracture |
| Experiment | (mm) | (mm) | (kN) | (rpm) | (kN) | shoulder | plate | (mm) | plate | (mm) | (kN) | mode |
| 1 | 7 | 4 | 5 | 2000 | 12 | 1.07 | 6000 | 1.0 | 980 | 1.2 | 3.39 | Plug |
| | | | | | | | series AI | | MPa-class | | | |
| | | | | | | | | | steel | | | |
| 2 | 7 | 4 | 5 | 2000 | 12 | 1.07 | 6000 | 1.0 | 980 | 1.2 | 3.56 | Plug |
| | | | | | | | series AI | | MPa-class | | | |
| | | | | | | | | | steel | | | |
| 3 | 7 | 4 | 5 | 2000 | 12 | 1.07 | 6000 | 1.0 | 980 | 1.2 | 3.35 | Plug |
| | | | | | | | series AI | | MPa-class | | | |
| | | | | | | | | | steel | | | |

As shown in Table 8, when the experiment was performed three times under the conditions that the outer diameter of the pin 11 is 4 mm, the outer diameter of the shoulder 12 is 7 mm, the pressing load of the clamp 13 is 5 kN, the rotation speed of the tool 1 is 2000 rpm, the pressing force when the shoulder 12 is press-fitted is 12 kN, a press-fitting depth of the shoulder is 1.07 mm, the upper plate 31 includes a 6000 series aluminum alloy having the upper plate thickness T1 of 1.0 mm, and the lower plate 32 includes a 980 MPa-class steel having the lower plate thickness T2 of 1.2 mm, the occurring fracture modes are all plug fracture in a range of the tensile strength of 3.35 kN or more and 3.56 kN. Under such conditions, it has been also confirmed that the stir-welded portion 4 has the welding bottom surface 4B, the anchor 4A, the hooking 4F, and the indent 4T, and thus, the fracture mode can be stably controlled to be a plug fracture.

The presenters of the present disclosure have confirmed that the fracture mode of the welded body 3 can be controlled to be a plug fracture in a similar manner to the above under the following conditions.

Table 9 shows upper and lower limits of the outer diameters of the pin 11 and the shoulder 12 of the tool 1, the clamp load, the rotation speed, the press-fitting pressing force, and a press-fitting amount of the lower plate as welding conditions, and the materials and the plate thicknesses of the upper plate 31 and the lower plate 32 as a set of plates. The press-fitting amount of the lower plate corresponds to a depth at which the shoulder 12 is press-fitted into the lower plate 32 with respect to the lower plate front surface 32A. At this time, in Table 9, the lower limit is indicated as zero, but specifically, it means a value larger than zero (the same applies to Tables 10 and 11 hereinafter). The upper plate 31 is manufactured by die casting, that is, so-called metal mold casting. Each parameter shown in Table 9 can be independently set between the upper and lower limits. The same applies to the following tables.

TABLE 9

| | | | Welding conditions | | | | | | | |
|---|---|---|---|---|---|---|---|---|---|---|
| | | | | | Press- | Press- | | | | |
| | Tool dimension | | | | fitting | fitting | Set of plates | | | |
| | Shoulder | Pin | Clamp | Rotation | pressing | amount | | Plate | | Plate |
| | diameter | diameter | load | speed | force | (mm) of | Upper | thickness | Lower | thickness |
| | (mm) | (mm) | (kN) | (rpm) | (kN) | lower plate | plate | (mm) | plate | (mm) |
| Lower limit | 5 | 3 | 4 | 800 | 9 | 0 | 5000, | 1.0 | 270 MPa- | 0.7 |
| | | | | | | | 6000 series | | class steel | |
| Upper limit | 9 | 6 | 10 | 4000 | 25 | 1.0 | AI, die | 3.5 | 1.5 GPa- | 1.8 |
| | | | | | | | casting | | class steel | |

As more desirable conditions, Table 10 shows the upper and lower limits of the outer diameters of the pin 11 and the shoulder 12 of the tool 1, the clamp load, the rotation speed, the press-fitting pressing force, and the press-fitting amount of the lower plate as welding conditions, and the materials and the plate thicknesses of the upper plate 31 and the lower plate 32 as a set of plates.

TABLE 10

| | | | Welding conditions | | | | | | | |
|---|---|---|---|---|---|---|---|---|---|---|
| | | | | | Press- | Press- | | | | |
| | Tool dimension | | | | fitting | fitting | Set of plates | | | |
| | Shoulder | Pin | Clamp | Rotation | pressing | amount | | Plate | | Plate |
| | diameter | diameter | load | speed | force | (mm) of | Upper | thickness | Lower | thickness |
| | (mm) | (mm) | (kN) | (rpm) | (kN) | lower plate | plate | (mm) | plate | (mm) |
| Lower limit | 5 | 3 | 5 | 2000 | 10 | 0 | 6000 | 1.0 | 780 MPa- | 1.0 |
| | | | | | | | series AI | | class steel | |
| Upper limit | 7 | 5 | 7 | 3000 | 15 | 0.3 | 6000 | 1.4 | 1.5 GPa- | 1.2 |
| | | | | | | | series AI | | class steel | |

As even more desirable conditions, Table 11 shows the upper and lower limits of the outer diameters of the pin 11 and the shoulder 12 of the tool 1, the clamp load, the rotation speed, the press-fitting pressing force, and the press-fitting amount of the lower plate as welding conditions, and the materials and the plate thicknesses of the upper plate 31 and the lower plate 32 as a set of plates.

TABLE 11

| | | | Welding conditions | | | | | | | |
|---|---|---|---|---|---|---|---|---|---|---|
| | | | | | Press- | Press- | | | | |
| | Tool dimension | | | | fitting | fitting | Set of plates | | | |
| | Shoulder | Pin | Clamp | Rotation | pressing | amount | | Plate | | Plate |
| | diameter | diameter | load | speed | force | (mm) of | Upper | thickness | Lower | thickness |
| | (mm) | (mm) | (kN) | (rpm) | (kN) | lower plate | plate | (mm) | plate | (mm) |
| Lower limit | 5 | 3 | 6 | 2000 | 12 | 0 | 6000 | 1.0 | 980 MPa- | 1.0 |
| | | | | | | | series AI | | class steel | |
| Upper limit | 7 | 4 | 7 | 2000 | 13 | 0.41 | 6000 | 1.1 | 1.2 GPa- | 1.2 |
| | | | | | | | series AI | | class steel | |

In any case, since the stir-welded portion 4 has the welding bottom surface 4B, the anchor 4A, the hooking 4F, and the indent 4T, the plug fracture can be promoted, and the number of occurrences of interface fracture can be reduced. At this time, it has been confirmed that when the stir-welded portion 4 does not have the indent 4T, the number of occurrences of interface fracture relatively increases. Since the stir-welded portion 4 has the indent 4T and the effective distance K is 77.0% or less of the reference distance TS, the occurring fracture mode can be further controlled to be plug fracture, and the occurrence of the interface fracture can be reduced. By setting the anchor height A to 55.3% or more and less than 100% of the reference distance TS, the plug fracture can be further promoted, and the number of occurrences of interface fracture could be reduced. In comparison with the range shown in Table 9, the plug fracture can be controlled with higher accuracy in the ranges shown in Tables 10 and 11. In comparison with the range shown in Table 10, the plug fracture can be controlled with even higher accuracy in the range shown in Table 11.

Note that the present disclosure is not limited to the above conditions. Under other conditions, when the stir-welded portion 4 has the indent 4T, the stir-welded portion 4 has the weakest portion as compared with a case where the stir-welded portion 4 does not have the indent 4T, and thus, the fracture mode can be controlled to be plug fracture.

Although the welded body 3, the method for friction stir spot welding, and the friction stir spot welding device M of the present disclosure have been described above, the present disclosure is not limited to the above embodiments at all. For example, the welded body 3 and the like described above can take the following modified embodiments.

In the above description, the upper plate 31 and the lower plate 32 each include one plate material, but the present disclosure is not limited to this configuration. At least one of the upper plate 31 or the lower plate 32 may include a plurality of members disposed to overlap in the overlapping direction. The plurality of members may be connected by an adhesive material or the like. In such a configuration, the upper plate 31 and the lower plate 32 can be still firmly welded to each other, the occurrence of interface fracture is suppressed, and even if a fracture occurs, a plug fracture can be prioritized.

### SUMMARY OF PRESENT DISCLOSURE

The specific embodiments described above include a disclosure having the following configurations.

A welded body according to a first aspect of the present disclosure includes a first member including a metal and having a first front surface and a first back surface, a second member that includes a metal, has a second front surface and a second back surface, and is disposed to form an overlapping portion in which at least a part of the second front surface abuts on the first back surface and the first member and the second member overlap each other, and a welded portion in which the first member and the second member are welded by friction stir welding. The welded portion includes a welding bottom surface that is a ring-shaped interface of the first member and the second member and is generated at a position deeper than the second front surface with respect to the first front surface, an inner raised portion in which a part of the second member is raised to a position higher than the second front surface with respect to the welding bottom surface on a radially inner side of the welding bottom surface, an outer raised portion in which a part of the second member is raised to a position higher than the second front surface with respect to the welding bottom surface on a radially outer side of the welding bottom surface, and a recessed portion that is disposed to face the welding bottom surface in an overlapping direction of the first member and the second member and in which a part of the first front surface is recessed.

In this configuration, the welded portion in which the first member and the second member are welded to each other includes the welding bottom surface, the inner raised portion, the outer raised portion, and the recessed portion. On the welding bottom surface, a part of the first member is disposed to be wedged into a position deeper than the second front surface. On the radially inner side of the welding bottom surface, a part of the second member is disposed as the inner raised portion so as to be raised to a position higher than the first back surface. Furthermore, on the radially outer side of the welding bottom surface, a part of the second member is disposed as the outer raised portion so as to be raised to a position higher than the first back surface. As a result, the first member and the second member are firmly welded to each other to enhance strength of the first member and the second member.

Furthermore, by the formation of the recessed portion above the welding bottom surface, a cross section of the first front surface becomes discontinuous, and a weakest portion can be intentionally formed between an end (corner) of the recessed portion and a top of the outer raised portion. Therefore, even if a fracture occurs in the welded portion due to some sudden or temporal cause after the manufacture of the welded body, the occurrence of a plug fracture can be prioritized by concentrating a stress on the weakest portion, and the occurrence of interface fracture can be suppressed. Furthermore, since each of the inner raised portion and the outer raised portion is wedged toward the first member, an unstable interface fracture at the interface of the first member and the second member can be prevented, and a plug fracture can be stably obtained. Therefore, it is possible to visually recognize the occurrence of a fracture in the welded portion from the outside, and it is possible to easily and quickly find and deal with the fracture.

A welded body according to a second aspect of the present disclosure is the welded body according to the first aspect, in which an effective distance that is a distance from a top of the outer raised portion to a bottom of the recessed portion in the overlapping direction is 77.0% or less of a reference distance that is the distance from the first back surface to a bottom of the recessed portion in the overlapping direction.

In this configuration, by further concentrating the stress on the weakest portion between the end of the recessed portion and the top of the outer raised portion, the occurrence of the plug fracture can be prioritized and the occurrence of the interface fracture can be suppressed.

A welded body according to a third aspect of the present disclosure is the welded body according to the first or second aspect, in which a height of the inner raised portion that is a distance from the second front surface to a top of the inner raised portion in the overlapping direction is 55.3% or more and less than 100% of the reference distance that is the distance from the first back surface to the bottom of the recessed portion in the overlapping direction.

This configuration can cause the first member and the second member to be more firmly welded to each other and enhance strength of the first member and the second member. In addition, the unstable interface fracture at the interface of the first member and the second member can be further prevented, and the plug fracture can be stably obtained.

A welded body according to a fourth aspect of the present disclosure is the welded body according to the first to third aspects, in which a melting point of the first member is lower than a melting point of the second member.

In this configuration, since a part of the second member can be wedged into a higher position of the first member having a relatively low melting point by friction stir spot welding, the inner raised portion and the outer raised portion can be formed more stably.

A welded body according to a fifth aspect of the present disclosure is the welded body according to the first to fourth aspects, in which the first member includes a plurality of members disposed to overlap each other in the overlapping direction.

In this configuration, the first member and the second member can be still firmly welded to each other, the occurrence of interface fracture is suppressed, and even if a fracture occurs, a plug fracture can be prioritized.

A method for friction stir spot welding according to an aspect of the present disclosure includes welding a first member that includes a metal and has a first front surface and a first back surface and a second member that includes a metal and has a second front surface and a second back surface by softening the first member and the second member with frictional heat. The method for friction stir spot welding includes preparing a friction stir spot welding device including a pin and a shoulder having a cylindrical shape and a hollow portion into which the pin is inserted, arranging the first member and the second member to form an overlapping portion in which at least a part of the second front surface abuts on the first back surface and the first member and the second member overlap each other, arranging the pin and the shoulder to face the overlapping portion, press-fitting the shoulder to a press-fitting position deeper than the second front surface with respect to the first front surface in the overlapping portion in a state where the pin is retracted from the first front surface, and forming a welding bottom surface that is an interface of the first member and the second member, after forming the welding bottom surface, retracting the shoulder from the press-fitting position and causing the pin to enter the overlapping portion, and forming a recessed portion that is disposed to face the welding bottom surface in an overlapping direction of the first member and the second member and in which a part of the first front surface is recessed by the shoulder and the pin, and along with formation of the welding bottom surface and the recessed portion, forming an inner raised portion in which a part of the second member is raised to a position higher than the second front surface with respect to the welding bottom surface on a radially inner side of the welding bottom surface, and forming an outer raised portion in which a part of the second member is raised to a position higher than the second front surface with respect to the welding bottom surface on a radially outer side of the welding bottom surface.

A method for friction stir spot welding according to another aspect of the present disclosure is the method for friction stir spot welding according to the aspect of the aspect and further includes, after forming the welding bottom surface, forming the recessed portion by retracting the shoulder from the press-fitting position while rotating the shoulder and by arranging a distal end surface of the shoulder at a position between the first front surface and the first back surface.

A friction stir spot welding device according to another aspect of the present disclosure welds a first member that includes a metal and has a first front surface and a first back surface and a second member that includes a metal and has a second front surface and a second back surface by softening the first member and the second member with frictional heat. The friction stir spot welding device includes a welding tool including a pin having a central axis, the welding tool including a shoulder having a cylindrical shape and a hollow portion into which the pin is inserted, a rotation mechanism that allows the welding tool to rotate about the central axis, a movement mechanism that allows each of the pin and the shoulder to move independently in a direction in which the central axis extends, and a control unit that controls each of the rotation mechanism and the movement mechanism. In a state where the first member and the second member are disposed to form an overlapping portion in which at least a part of the second front surface abuts on the first back surface and the first member and the second member overlap each other, and the pin and the shoulder are disposed to face the overlapping portion, the control unit controls each of the rotation mechanism and the movement mechanism to cause the pin to retract from the first front surface, press-fit the shoulder to a press-fitting position deeper than the second front surface with respect to the first front surface in the overlapping portion, and form a welding bottom surface that is an interface of the first member and the second member by the shoulder, after formation of the welding bottom surface, the control unit controls each of the rotation mechanism and the movement mechanism to cause the shoulder to retract from the press-fitting position, cause the pin to enter the overlapping portion, and form, by the shoulder and the pin, a recessed portion that is disposed to face the welding bottom surface in an overlapping direction of the first member and the second member and in which a part of the first front surface is recessed, and along with formation of the welding bottom surface and the recessed portion, the control unit controls each of the rotation mechanism and the movement mechanism to form an inner raised portion in which a part of the second member is raised to a position higher than the second front surface with respect to the welding bottom surface on a radially inner side of the welding bottom surface, and an outer raised portion in which a part of the second member is raised to a position higher than the second front surface with respect to the welding bottom surface on a radially outer side of the welding bottom surface.

1. A welded body comprising:
a first member including a metal and having a first front surface and a first back surface;
a second member that includes a metal, has a second front surface and a second back surface, and is disposed to form an overlapping portion in which at least a part of the second front surface abuts on the first back surface and the first member and the second member overlap each other; and
a welded portion in which the first member and the second member are welded by friction stir welding,
wherein the welded portion includes
a welding bottom surface that is a ring-shaped interface of the first member and the second member and is generated at a position deeper than the second front surface with respect to the first front surface,
an inner raised portion in which a part of the second member is raised to a position higher than the second front surface with respect to the welding bottom surface on a radially inner side of the welding bottom surface,
an outer raised portion in which a part of the second member is raised to a position higher than the second front surface with respect to the welding bottom surface on a radially outer side of the welding bottom surface, and
a recessed portion that is disposed to face the welding bottom surface in an overlapping direction of the first member and the second member and in which a part of the first front surface is recessed, and
an effective distance that is a distance from a top of the outer raised portion to a bottom of the recessed portion in the overlapping direction is 77.0% or less of a reference distance that is a distance from the first back surface to the bottom of the recessed portion in the overlapping direction.

2. (canceled)

3. The welded body according to claim 1, wherein a height of the inner raised portion that is a distance from the second front surface to a top of the inner raised portion in the overlapping direction is 55.3% or more and less than 100% of the reference distance that is the distance from the first back surface to the bottom of the recessed portion in the overlapping direction.

4. The welded body according to claim 1, wherein a melting point of the first member is lower than a melting point of the second member.

5. The welded body according to claim 1, wherein the first member includes a plurality of members disposed to overlap each other in the overlapping direction.

6. A method for friction stir spot welding of welding a first member that includes a metal and has a first front surface and a first back surface and a second member that includes a metal and has a second front surface and a second back surface by softening the first member and the second member with frictional heat, the method comprising:
preparing a friction stir spot welding device including a pin and a shoulder having a cylindrical shape and a hollow portion into which the pin is inserted;
arranging the first member and the second member to form an overlapping portion in which at least a part of the second front surface abuts on the first back surface and the first member and the second member overlap each other;
arranging the pin and the shoulder to face the overlapping portion;
press-fitting the shoulder to a press-fitting position deeper than the second front surface with respect to the first front surface in the overlapping portion in a state where the pin is retracted from the first front surface, and forming a welding bottom surface that is an interface of the first member and the second member;
after forming the welding bottom surface, retracting the shoulder from the press-fitting position and causing the pin to enter the overlapping portion, and forming a recessed portion that is disposed to face the welding bottom surface in an overlapping direction of the first member and the second member and in which a part of the first front surface is recessed by the shoulder and the pin; and
along with formation of the welding bottom surface and the recessed portion, forming an inner raised portion in which a part of the second member is raised to a position higher than the second front surface with respect to the welding bottom surface on a radially inner side of the welding bottom surface, forming an outer raised portion in which a part of the second member is raised to a position higher than the second front surface with respect to the welding bottom surface on a radially outer side of the welding bottom surface, and setting an effective distance that is a distance from a top of the outer raised portion to a bottom of the recessed portion in the overlapping direction to 77.0% or less of a reference distance that is a distance from the first back surface to a bottom of the recessed portion in the overlapping direction.

7. The method for friction stir spot welding according to claim 6, further comprising
after forming the welding bottom surface, forming the recessed portion by retracting the shoulder from the press-fitting position while rotating the shoulder and by arranging a distal end surface of the shoulder at a position between the first front surface and the first back surface.

8. A friction stir spot welding device that welds a first member that includes a metal and has a first front surface and a first back surface and a second member that includes a metal and has a second front surface and a second back surface by softening the first member and the second member with frictional heat, the friction stir spot welding device comprising:
a welding tool including a pin having a central axis, the welding tool including a shoulder having a cylindrical shape and a hollow portion into which the pin is inserted;
a rotation mechanism that allows the welding tool to rotate about the central axis;
a movement mechanism that allows each of the pin and the shoulder to move independently in a direction in which the central axis extends; and
a control unit that controls each of the rotation mechanism and the movement mechanism,
wherein in a state where the first member and the second member are disposed to form an overlapping portion in which at least a part of the second front surface abuts on the first back surface and the first member and the second member overlap each other, and the pin and the shoulder are disposed to face the overlapping portion, the control unit controls each of the rotation mechanism and the movement mechanism to cause the pin to retract from the first front surface, press-fit the shoulder to a press-fitting position deeper than the second front surface with respect to the first front surface in the overlapping portion, and form a welding bottom surface that is an interface of the first member and the second member by the shoulder,
after formation of the welding bottom surface, the control unit controls each of the rotation mechanism and the movement mechanism to cause the shoulder to retract from the press-fitting position, cause the pin to enter the overlapping portion, and form, by the shoulder and the pin, a recessed portion that is disposed to face the welding bottom surface in an overlapping direction of the first member and the second member and in which a part of the first front surface is recessed, and
along with formation of the welding bottom surface and the recessed portion, the control unit controls each of the rotation mechanism and the movement mechanism to form an inner raised portion in which a part of the second member is raised to a position higher than the second front surface with respect to the welding bottom surface on a radially inner side of the welding bottom surface, and an outer raised portion in which a part of the second member is raised to a position higher than the second front surface with respect to the welding bottom surface on a radially outer side of the welding bottom surface, and set an effective distance that is a distance from a top of the outer raised portion to a bottom of the recessed portion in the overlapping direction to 77.0% or less of a reference distance that is a distance from the first back surface to the bottom of the recessed portion in the overlapping direction.
